(19) United States
(12) Patent Application Publication
(10) Pub. No.: US 2005/0034614 A1
(43) Pub. Date: Feb. 17, 2005

(54) Screen printing screen, screen, screen frame, screen joining method, screen spreading method, painting canvas, advertisement sheet, and planer mirror

(76) Inventor: Furetsu Kasuya, Kodaira-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/619,461

(22) Filed: Jul. 16, 2003

Related U.S. Application Data
(63) Continuation of application No. PCT/JP02/00241, filed on Jan. 16, 2002.

(30) Foreign Application Priority Data
Jan. 16, 2001 (JP) 2001-008049

(51) Int. Cl. B41L 13/00

(52) U.S. Cl. 101/127.1

(57) ABSTRACT

The present invention relates to a screen for screen printing. More particularly, the structure of the screen can have different types of mesh or sheets joined together. The present invention also relates to a method of detachably spreading a screen to a screen frame.

This application is a continuation of International Application No. PCT/JP02/00241, with an international filing date of Jan. 16, 2002.

### TECHNICAL FIELD

The present invention relates to a screen for screen printing. More particularly, it relates to a novel structure screen having different types of mesh or sheet joined together. Moreover, the present invention relates to a method of detachably spreading a screen to a screen frame, a screen frame relating the method, and a method of fabricating a planer mirror.

### BACKGROUND ART

A conventional screen is proposed having a less expandable or mainly metal mesh provided as an image forming portion at the center thereof and another mesh of a larger size provided about the image forming portion which is greater in the elasticity than the image forming portion (Japanese Utility Model Application Publication (JP-Y) No. 51-9297). More specifically, two types of mesh which are different in the expandability are joined together to construct the screen. In similar respects, another screen is known having a stainless steel mesh provided as the image forming portion and surrounded by a polyester mesh. Also, a further screen structure is known having the image forming portion located not at the center but biased toward the upper, lower, left, or right (Japanese Patent Application Laid-open (JP-A) No. 2-00494).

As having two or more meshes overlapped, a combination mask is proposed where the edge of a metal sheet having imaging perforations of a printing surface is implemented by the two meshes overlapped (JP-A No. 9-150497).

Another is proposed having one mesh provided with a reinforcement between the frame and the image forming portion. The reinforcement is a sheet material or is made by curing an adhesive (JP-A No. 11-170719).

Some screens of mesh and sheet combined type are known having a stainless steel mesh provided as the image forming portion and surrounded by a polyester film.

### DISCLOSURE OF THE INVENTION

However, the joint between two different material screens, such as a metal sheet and a synthetic resin mesh, or between two different types, such as a mesh and a sheet, may be declined in the bonding strength hence resulting in detachment when the spreading force is high. Also, the joint may hardly last long in use.

When two screens are joined or overlapped, their joint generates a step. The step on the screens interrupts the movement of a squeegee during the printing, hence causing the squeegee to be injured, the joint to be separated, or the screens themselves may be fractured.

As the screen for screen printing is spread while attached, the screen frame has to be rigid enough to stand the force of tension and its material may be woods or metals. Accordingly, the screen frame will be heavy and bulky.

Also, the screen is commonly attached by an adhesive agent to the screen frame and not allowed to detach readily for ease of storage or transportation.

The screen frame is sometimes saved for re-use in the future. As the screen frame remains loaded with the screen, its storage will require a considerable size of space such as a warehouse and thus be unfavorable in the cost-reduction.

Also, when the screen is stored as remaining attached to the screen frame, it may be stretched out thus resulting in the distortion of a print image.

In general, the facility for fabricating the screen is distanced from the plant for developing print images or producing prints. It is therefore laborious, uneconomical, and inconvenient to carry or transport the bulky screen frame with the screen from one place to another.

It is also troublesome for re-use to have the screen frame separated from the screen and cleaned down.

Every conventional screen frame arranged variable in the length of its frame sides is equipped with a bulky screen size adjusting means and will thus be handed with much difficulty and hardly be practical.

Also, no screen frame has been proposed in which the screen frame arranged variable in the length of its frame sides is improved in combination with screen hooking tools joined with a screen for spreading the screen, controlling the tension on the screen, or allowing the screen hooking tools to be attached and detached with ease.

It is not an easy task for increasing the quality of printing to eliminate or correct any dimensional error on an object to be printed or any spreading fault on the screen which may lead to a lift-off printing and create unwanted distortion or skew on a print.

Moreover, It is a good idea for improving the quality of printing to conduct a proper correcting action to eliminate any unwanted distortion or skew on a print when the screen has been fixed to the screen frame and operated for trial printing. However, this is not easy.

A screen printing screen frame which is variable in the length of its frame sides and to which a screen is attached or with the use of screen hooking tools fixed to the screen to spread the screen is provided as characterized by the screen printing screen frame having each screen frame side thereof or each frame side intermediate portion fitted loosely to an end portion of each corner of the screen frame, the screen hooking tools fixed to the screen, fitting portions or joints on the upper surface of each frame side of the screen frame for detachably fitting and hooking the screen hooking tools, and screen frame side length extensible means which consists mainly of male thread receivers provided with female threads provided to extend from each end of the frame corner via the frame side to a corresponding end of the other frame corner or female threads provided in the frame side intermediate portions and male threads provided for mating with the male thread receivers or the female threads of the frame corners.

A screen printing screen frame having frame sides made of a metal or a synthetic resin material and arranged of an orthogonal shape, a hollow orthogonal shape, a C shape, or an L shape in the cross section for spreading a screen printing screen is provided as characterized by the frame sides of a hollow tube closed or the frame sides of a hollow tube provided with openings at one end and having an orthogonal shape or a C shape or an L shape in the cross section and welded or fixed to one another, a number of thread apertures provided in the side surfaces of the hollow or orthogonal frame sides or in the inner or outer side surface or the inner, outer, or both side surfaces of the C shape frame sides or in the side and outer sides of the L shape frame sides, tension adjusting bars having the predetermined number of thread apertures and the predetermined number of female thread apertures provided at a corresponding portion to the thread apertures and tension adjusting screws threaded into the female thread apertures and inserted into or built-in the hollows of the frame sides or into the orthogonal frame sides or into the C shape of the C shape frame sides or into the L shape frame sides, wherein the tension on the screen is controlled by the frame sides deflecting horizontally with the tension adjusting screws moving forward and backward thus to eliminate unwanted distortion or skew of images on a print. Also, a method of bonding, curing, and embossing of mesh or sheet screens comprises the steps of butt joining or overlap joining screens together; providing a peelable sheet or an embossed peelable sheet on the upper, lower, or both sides of the bonded or cured joint and securing the joint with an adhesive agent or by thermal fusing or providing a set of molds to the joint and filling the molds with a molding agent; removing the peelable sheet or the embossed peelable sheet or the molds after the molding agent is cured; and smoothing the upper, and lower, or both sides of the bonded or cured joint, whereby a step at the joint between the screens is filled or the mesh is sealed with the adhesive agent and the screens are covered with a layer of the adhesive agent or embossed at the surface.

Also, a method of spreading a screen printing screen comprises the steps of providing hooking portions in a screen frame, which is variable in each side length, for accepting screen hooking tools; hooking the screen hooking tools of a screen into the hooking portions or fixing the screen to the screen frame; and adjusting the length of each side of the screen frame with the use of screen frame adjusting means to give a tension on the screen suited for the printing.

Moreover, a screen frame which is variable in the length of its sides is provided as characterized by assembling four L-shaped corners and four frame sides, which have insertion apertures provided in both ends thereof for accepting the L-shaped corners, by inserting the four L-shaped corners at their end into the insertion apertures to develop a screen frame construction provided with screen frame side length extensible means, or locating four L-shaped frame sides, each frame side composed of a long side and a short side joined in an L shape and has an insertion aperture provided in one end of the long side thereof for accepting the short side of an adjacent L-shaped frame side, so that the long side of each frame side is opposite to the short side of a neighbor frame side and inserting the short sides into the corresponding long sides to develop a screen frame construction provided with screen frame side length extensible means, or assembling four L-shaped corner frame side, defined by separating a screen frame at the center of each side and having insertion apertures provided in both ends thereof for accepting auxiliary frame sides, by inserting the auxiliary frame sides into the corresponding insertion apertures of the L-shaped corner frame sides to develop a screen frame construction provided with screen frame side length extensible means.

According to the aspect of the present invention, the screen can precisely be adjusted for correcting images on a print once printed by inserting the tension adjusting bars of a metal into the opening of the hollow frame sides of the screen frame, threading the screws into the tension adjusting screw apertures provided in the inner or the outer or both surfaces of the frame sides and the female thread apertures provided in the tension adjusting bars, and moving the tension adjusting screws horizontally to and from the frame sides thus to deflect the screen.

With the tension adjusting screws moved forward and backward from the outside of the frame sides, the tension on the screen can be adjusted to eliminate unwanted distortion or skew of image on a print.

The screen frame is constructed where the hollow frame sides of aluminum or any other metal arranged of an orthogonal shape in the cross section are jointed by welding with the opening at one end thereof exposed.

The frame sides may be arranged of a C shape or an L shape in the cross section with equal success.

Each of the frame sides of the screen frame has the screw apertures provided at given intervals in the inner, outer, or both surfaces thereof through which the tension adjusting screws are threaded. The tension adjusting bar of a hollow form has also the thread apertures provided corresponding to the screw apertures of the frame side and are inserted into the opening of the corresponding frame side (four bars in the total).

The tension adjusting bars may be made of a metal having an orthogonal shape in the cross section. As the tension adjusting bars are deflected by the action of the screws, they are preferably high in the hardness (e.g., as tempered).

The tension adjusting bars are tightened at both ends to the corresponding frame sides by the retaining screws threaded vertically from above. The retaining screws at both ends can thus act as the fulcrums for slightly deflecting the frame side at the center.

The male screws are provided for inserting through the screw apertures of the frame sides and the thread apertures of the tension adjusting bars for joining each other.

As the screen has been attached to the screen frame, the tension on the screen can be adjusted after trial printing of images by the following manner.

With the tension adjusting screws moved forward and backward separately, the frame sides can slightly be deflected inward and outward thus to adjust the tension on the screen.

Also, the turning of the male screws may be driven by an external servo motor.

Alternatively, the turning movement can desirably be controlled by a computer calculating discrepancy of image between the screen and its print from the location of image positioning markings at every action of the printing and determining the distance for movement of the screen frame.

As the screen frame is loaded with the screen, its frame sides can precisely be deflected inwardly and outwardly by horizontally moving the tension adjusting screws from the outside and inside to eliminate unwanted distortion or skew on the screen after trial printing of image.

The tension adjusting screws may be headless screws with the top slotted or set screw or common machine screws with the head.

The tension adjusting screws may be provided at either the inner or outer side or both sides of each frame side as described in the embodiments. When the frame side is provided with the screws at both sides, it can be tightened from both sides with the two screws urging in opposite directions thus being in a so-called double locking state. This permits the screen frames to remain not moved after the adjustment thus being advantageous for use in the precision screen printing.

As the screen frame is simply deflected for minimum adjustment, it can be prevented from physical breakdown.

### BRIEF DESCRIPTION OF THE DRAWINGS

FIGS. 1(a)-1(h) illustrate the cross section of an enlarged part of the screen explaining steps of joining screens, FIGS. 1a and 1b being partially enlarged cross sectional views of screens showing steps of bonding, FIGS. 1c and 1d being partially enlarged cross sectional views of screens showing a step of bonding and the completion of bonding, FIGS. 1e and 1f being partially enlarged cross sectional views of screens showing a step of bonding and the completion of bonding, and FIGS. 1g and 1h being partially enlarged cross sectional views of screens showing a step of bonding and the completion of bonding;

FIGS. 2(a)-2(c) illustrate steps of spreading the screen, FIG. 2a being a view showing a relationship between the screen hooking tools joined with the screen and the screen frame, FIG. 2b being a schematic view showing a step of expanding the screen frames to which the screen hooking tools joined with the screen are attached, and FIG. 2c being a schematic view showing a step of spreading the screen through expanding the screen frames to which the screen hooking tools joined with the screen are attached;

FIGS. 3(a)-3(c) illustrate examples of the screen frame arranged variable in the frame side length, FIG. 3a being a plan view showing one example of the screen frame equipped with auxiliary frame sides before and after the expansion, FIG. 3b being a plan view showing another example of the screen frame equipped with no auxiliary frame sides before and after the expansion, and FIG. 3c being a plan view showing a further example of the screen frame equipped with auxiliary frame sides at the center of each side before and after the expansion;

FIGS. 4(a)-4(c) illustrate the cross section of a frame side of a screen frame arranged variable in the frame side length, FIG. 4a being a cross sectional view of one construction of the frame side, FIG. 4b being a cross sectional view of another construction of the frame side, and FIG. 4c being a cross sectional view of a further construction of the frame side;

FIGS. 5(a)-5(b) illustrate the cross section of the frame side arranged variable in the length, FIG. 5a being a cross sectional view of a further construction of the frame side and FIG. 5b being a cross sectional view of a still further construction of the frame side;

FIGS. 6(a)-6(b) illustrate a screen frame arranged variable in the length of its frame sides, FIG. 6a being a plan view and FIG. 6b being a cross sectional view taken along the line K-K of FIG. 6a;

FIGS. 7(a)-7(b) illustrate a screen frame arranged variable in the length of its frame sides and provided with male thread receivers, FIG. 7a being a plan view showing the male thread receivers and FIG. 7b being a cross sectional view taken along the line L-L of FIG. 7a;

FIG. 8 is a partially cut-off perspective view of the frame sides equipped with tension adjusting bars;

FIG. 9 is a partially cut-off plan view of the frame sides equipped with tension adjusting bars;

FIG. 10a is an enlarged cross sectional view at one end of one example of the frame side with a tension adjusting bar, FIG. 10b is an enlarged cross sectional view at one end of another example of the frame side having a C shape, and FIG. 10c is an enlarged cross sectional view at one end of a further example of the frame side having an L shape;

FIG. 11 is a partially cut-off enlarged view showing the relationship between the tension adjusting bar, the tension adjusting bar retaining screws, and the tension adjusting screws, where the two tension adjusting bar retaining screws are provided from the above and the below while the two tension adjusting screws are provided from the inside and the outside of the frame side;

FIG. 12 is a partially cut-off enlarged view showing the relationship between the tension adjusting bar, the tension adjusting bar retaining screw, and the tension adjusting screw, where the tension adjusting bar retaining screw is provided from the above while the tension adjusting screw is provided from the inside of the frame side; and

FIG. 13 is a partially cut-off enlarged view showing the relationship between the tension adjusting bar, the tension adjusting bar retaining screw, and the tension adjusting screw, where the tension adjusting bar retaining screw is provided from the below while the tension adjusting screw is provided from the outside of the frame side.

### BEST MODES FOR CARRYING OUT THE INVENTION

(Embodiment 1)

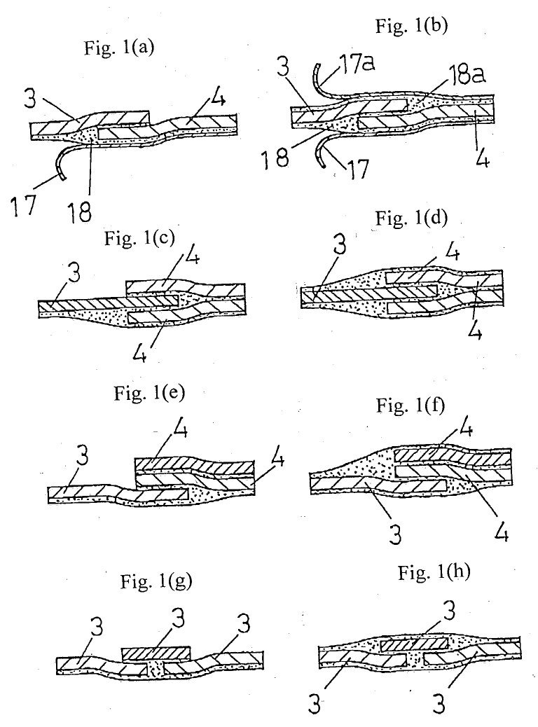

Embodiment 1 will be described referring to FIG. 1.

This is an inventive method of joining screen materials (meshes or sheets) together.

The inventive method is favorable in which different screens are joined together to have a more intricate structure screen.

For bonding, curing, and embossing of mesh or sheet screens, the method comprises the steps of butt joining or overlap joining screens together, providing a peelable sheet or an embossed peelable sheet on the upper, lower, or both sides of the bonded or cured joint and securing the joint with an adhesive agent or by thermal fusing or providing a set of molds to the joint and filling the molds with a molding agent, removing the peelable sheet or the embossed peelable sheet or the molds after the molding agent is cured, and smoothing the upper, and lower, or both sides of the bonded or cured joint, whereby a step at the joint between the screens is filled or the mesh is sealed with the adhesive agent and the screens are covered with a layer of the adhesive agent or embossed at the surface.

The joining of screens will be explained in more detail.

This embodiment is mainly featured with bonding, butt joining, and overlap joining of different screens.

For bonding a small screen to a large screen or joining different screens together in a patch-work arrangement, one is placed over or under the other thus inevitably creating a step along the joint. When a squeegee is used over the screen surface with such a step not eliminated, its movement may be not smoothed but interrupted hence resulting in injury of the screens. It is also common for overlap joining of screens to develop a step along the joint. A measure for eliminating the step will now be explained.

The joint between screens created by bonding, thermal fusing, or sealing is protected with a length of embossed peelable tape. As the joint has an embossed surface and its recessed portions serve as tiny ink pools permitting the ink to be milled with a squeegee, it can contribute to an improvement in the printing.

As the joint with the adhesive agent is strengthened, smoother, or embossed, it will hardly be fractured. Also, when the screens to be joined are of a mesh type, they can smoothly be applied with the adhesive agent from the lower side.

When the joint is embossed, its recessed portions receive ink and allows the squeegee to move forward and backward over and thus mill the ink, hence contributing to an improvement in the printing.

When the screens of a mesh type has to be sealed, the use of the peelable tape can increase the efficiency and quality of the sealing.

For the screens being provided with a layer of the adhesive agent or embossed, the use of the molds with the adhesive agent or the molding agent can cover a wider area at higher uniformity and efficiency.

FIG. 1 is described in more detail.

FIG. 1a illustrates the joining between a first screen 3 and a second screen 4. A peelable sheet 17 is attached by an adhesive agent to the lower side of the joint to develop a bonded region 18 before the adhesive agent is dried. Then, the adhesive agent is applied to the upper side to develop another bonded region 18a as shown in FIG. 1b. A peelable sheet 17a is provided to smooth the bonded region. After the adhesive agent is dried, the peelable sheet 17a is removed. The embossed surfaces can be obtained when the peelable sheets are of an embossed type.

FIGS. 1c, 1d, 1e, 1f, 1g, and 1h illustrate other examples of the joining and their descriptions are omitted.

(Embodiment 2)

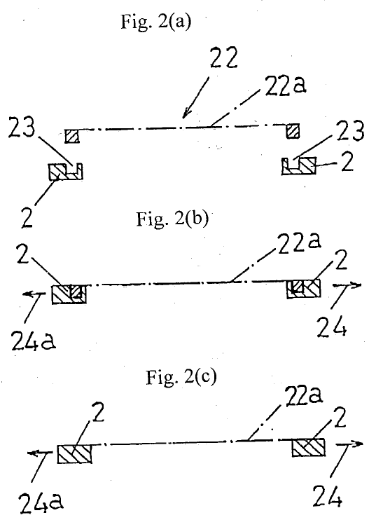

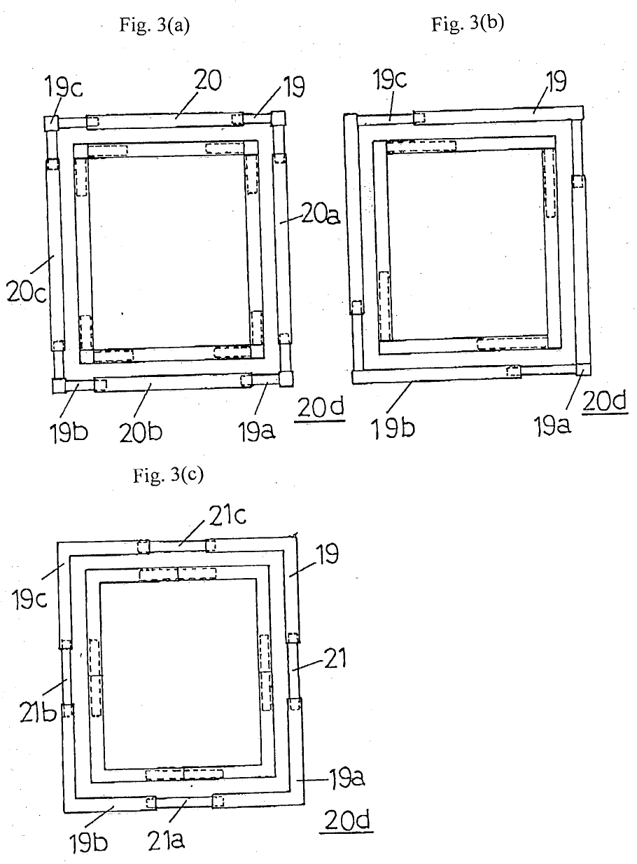

Embodiment 2 will now be described referring to FIGS. 2 and 3.

The following is an attempt for attaching a screen to a screen frame.

The method of spreading a screen printing screen comprises the steps of providing hooking portions in a screen frame, which is variable in each side length, for accepting screen hooking tools, hooking the screen hooking tools of a screen into the fitting portions or joining the screen to the screen frame, and adjusting the length of each side of the screen frame with the use of screen frame adjusting means to give a tension on the screen suited for the printing.

FIG. 2 illustrates a primary conception of the method of attaching a screen to a screen frame according to one embodiment of the present invention.

FIGS. 2a and 2b show a screen 22a held with its screen hooking tools 22 and spread by expanding two sides of a screen frame 2 in opposite directions 24 and 24a (outwardly of the screen frame).

Some examples of the means for expanding the two sides of the screen frame 2 are explained below.

FIG. 2c illustrates an example for attaching a screen to a screen frame where the screen 22a secured to the screen frame 2 is spread by moving two sides of the screen frame 2 in opposite directions 24 and 24a.

Some examples of the means for moving the two sides of the screen frame 2 are explained below.

The description is made in two steps.

(A) spreading of the screen 22a which is attached with its screen hooking tools 22 to hooking portions 25 provided on sides of a screen frame arranged variable in its side length.

The hooking portions 25 of the screen frame are not shown in FIG. 3.

The hooking portion 25 is provided on the top, outer, or inner surface of one of two opposite sides of an orthogonal or odd-number sided shape or of two adjacent sides or all sides of the screen frame. More specifically, one or more of the hooking portions 25 are implemented in the form of grooves, projections, or openings for accepting the corresponding screen hooking tools 22. With its screen hooking tools 22 received by the hooking portions 25, the screen can be spread.

With its hooking portions 25 holding the corresponding screen hooking tools 22, the screen frame is adjusted by expanding or contacting the length of the sides with screen frame adjusting means thus to give a tension on the screen suited for the printing. After the printing, the screen frame is retracted and separated from the screen hooking tools 22 of the screen.

The screen frame adjusting means may be implemented by a screw mechanism, a gear mechanism, a cylinder mechanism, a cam mechanism, a spring mechanism, a magnetic repulsion or attraction mechanism, a wedge mechanism, a telescopic mechanism, or a sliding mechanism which is driven by an electric, pneumatic, or hydraulic motor.

The screen may be spread with the following means.

The hooking portions 25 are provided on corresponding horizontal sliders 26. The hooking portions 25 are sized so that the horizontal sliders can travel parallelly and horizontally outwardly of the frame sides.

The hooking portions 25 are implemented in the form of grooves, projections, or openings on the top, outer, or inner surface of the horizontal sliders 26 thus to receive and hold the corresponding screen hooking tools 22 for spreading.

As the hooking portions 25 have receives the corresponding screen hooking tools 22, the horizontal sliders 26 are driven by a horizontal driving means selected from a screw mechanism, a gear mechanism, a cylinder mechanism, a cam mechanism, a spring mechanism, a magnetic repulsion or attraction mechanism, a wedge mechanism, a telescopic mechanism, or a sliding mechanism which is powered by an electric, pneumatic, or hydraulic motor.

The spreading of the screen can thus be controlled by determining the distance of movement of the horizontal sliders.

Another example is provided where a screen printing screen 22a is spread with a combination of a screen frame 20d arranged variable in the length of each side and screen hooking tools 22 joined to the screen 22a. The screen hooking tools 22 (joined to the screen 22a) are used under no tension.

The tension of the screen can be controlled by expanding the sides of the screen frame.

This allows the screen hooking tools 22 to be removed from the screen frame after completion of the printing and stored with the screen 22a being not spread. Accordingly, the screen 22a is prevented from unwanted stress or deformation during the storage and its operating life can be increased. As the screen 22a is stored and reused throughout a significant duration of time, it is particularly advantageous when the same printing is repeated at equal or different intervals of time.

After completion of the printing, the screen hooking tools 22 joined to the screen 22a are removed from the screen frame 2 and saved for re-use. Also, as the screen hooking tools 22 are joined with the screen 22a which is not bulky, its storage requires no extended space and will thus be economical. Their transportation will also be less troublesome.

As the screen hooking tools 22 are removed from the screen frame just after completion of the printing and minimized in both the weight and the size, they can be stored and transported with no difficulty.

More particularly, a screen frame which is variable in the length of its sides comprising assembling four L-shaped corners and four frame sides, which have insertion apertures provided in both ends thereof for accepting the L-shaped corners, by inserting the four L-shaped corners at their end into the insertion apertures to develop a screen frame construction provided with screen frame side length extensible means, or locating four L-shaped frame sides, each frame side composed of a long side and a short side joined in an L shape and has an insertion aperture provided in one end of the long side thereof for accepting the short side of an adjacent L-shaped frame side, so that the long side of each frame side is opposite to the short side of a neighbor frame side and inserting the short sides into the corresponding long sides to develop a screen frame construction provided with screen frame side length extensible means, or assembling four L-shaped corner frame side, defined by separating a screen frame at the center of each side and having insertion apertures provided in both ends thereof for accepting auxiliary frame sides, by inserting the auxiliary frame sides into the corresponding insertion apertures of the L-shaped corner frame sides to develop a screen frame construction provided with screen frame side length extensible means.

FIGS. 3a, 3b, and 3c illustrate pairs of the screen frames, the inner and the outer of each pair representing before and after the expansion of the frame sides. Also, as the screen corners 19 are modified in the size, their joining to the corresponding frame sides is shown in different forms.

FIG. 3c illustrates four of the auxiliary frame sides 21, 21a, 21b, and 21c. Two or more of the auxiliary frame sides 21, 21a, 21b, and 21c may be used at each side depending on the size of the screen frame.

It would also be understood that each side of the screen frame is separated into not only two but also three or more. The joining between two frame sides, between each corner and a frame side, or between two corners may be implemented by the repulsing and attracting action of a mechanism.

The means for expanding the frame side length of the screen frame may be implemented by a screw mechanism, a gear mechanism, a cylinder mechanism, a cam mechanism, a spring mechanism, a magnetic repulsion or attraction mechanism, a wedge mechanism, a telescopic mechanism, or a sliding mechanism which is driven by an electric, pneumatic, or hydraulic motor. As a large construction of the screen frame (e.g., 2 m×2 m) is hardly operated by hands, it can be equipped with an appropriate driving mechanism.

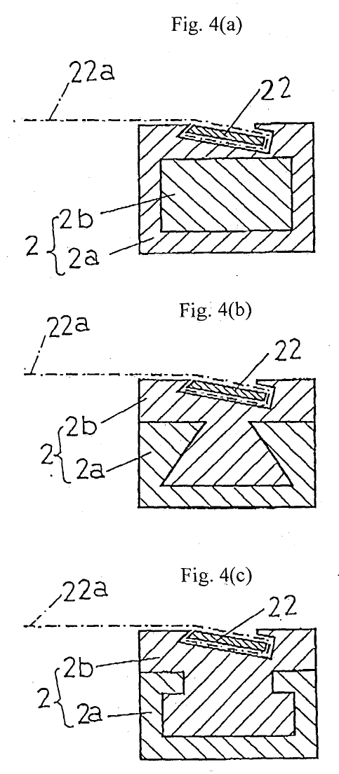

FIGS. 4a, 4b, and 4c illustrate examples of the screen frame arranged variable in the side length (the cross section of each frame side having one section arranged sliding along the other). So long as the side frame has one section arranged for sliding along the other for modifying the frame side length, its arrangement may be of no limitations.

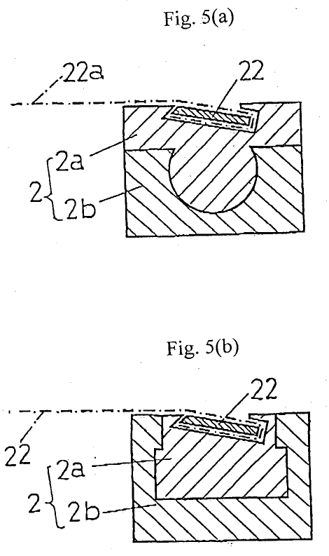

FIGS. 5a and 5b illustrate further examples of the screen frame arranged comprising two sections for one section sliding along the other for changing the side length (the cross section of each frame side having one section arranged sliding along the other). So long as the side frame has one section arranged for sliding along the other for modifying the frame side length, its arrangement may be of no limitations.

The means for expanding the side length of the screen frame may be implemented by a cylinder mechanism, a cam mechanism, a spring mechanism, a jack mechanism, an electromagnetic repulsion and attraction mechanism, a telescopic mechanism, or a slider mechanism.

The mechanism is provided inside or outside the screen frame and can be operated for expanding and contracting the frame side length.

The screen hooking tool 22 may be a frame which has a physical strength for attaching the screen at a tension not creating wrinkles, a physical strength for attaching the screen with no tension applied, each corner joined with an elastic material, each corner arranged flexible, each corner joined but not tightened, or each corner made of an elastic material.

The screen hooking tool 22 may be arranged flexible for expanding or contracting in a given range along the frame side.

The hooking portion 25 for receiving the screen hooking tool 22 may have a groove, dovetail, or slot construction provided on the top, outer, or inner surface of each frame side or two adjacent sides of the screen frame. Alternatively, the hooking portion 25 may be a projection(s) provided on the top, upper, or inner surface of each frame side for engaging with the corresponding recess(es) provided in the screen hooking tool 22. The hooking portion 25 may be a recess(es) provided in the top, upper, or inner surface of each frame side for engaging with a corresponding projection(s) provided on the screen hooking tool 22. The hooking portion 25 may be a male or female thread(s) provided on or in the top, upper, or inner surface of each frame side for thread engaging with a corresponding female or male thread(s) of the screen hooking tool 22.

(B) Tensioning of the screen 22a which is directly joined to the screen frame 20d arranged variable in the frame side length.

The screen 22a is joined with no use of the screen hooking tools 22 but directly to the screen frame 20d which is then adjusted in the side length for spreading the screen 22a.

As the screen is directly joined to the screen frame, it can never be detachable. The spreading of the screen can be made by controlling the length of the frame sides of the screen frame. The screen frame can be reused when the screen is replaced with new one after completion of the printing.

The technique for expanding and contracting the frame sides of the screen frame is identical to that of the previous embodiments and no further description will be made.

(Embodiment 3)

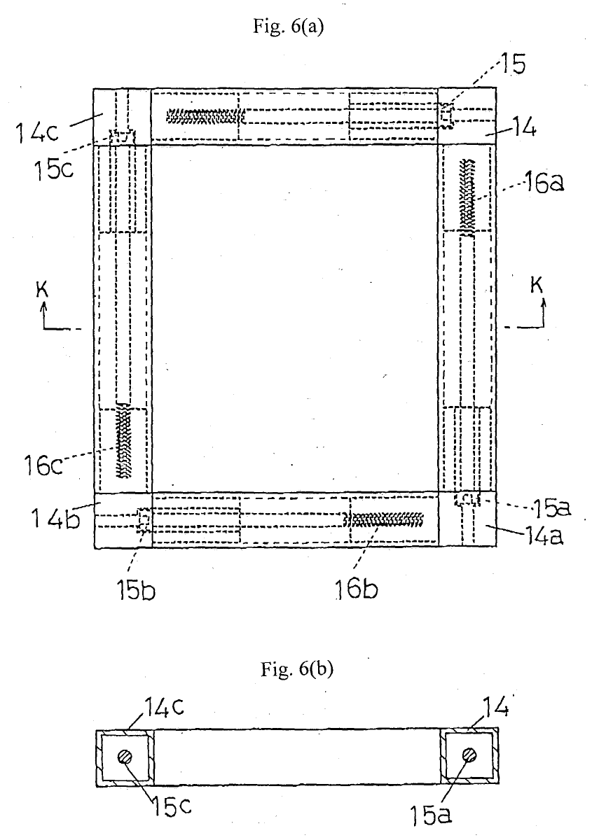

Embodiment 3 will be described referring to FIG. 6.

This relates to a screen frame employing the method of attaching a screen to a screen frame.

The hooking portions 25 for receiving the screen hooking tools 22 are not illustrated and will be explained in no more detail.

A screen printing screen frame which is variable in the length of its frame sides and to which a screen is attached or with the use of screen hooking tools fixed to the screen to spread the screen is characterized by the screen printing screen frame having each frame side thereof or each screen frame side intermediate portion thereof arranged for fitting loosely to each frame corner of the screen frame, the screen hooking tools fixed to the screen, fitting portions or joints of the screen fitting and hooking the screen hooking tools provided on the upper surface of each frame side for detachably, and screen frame side length extensible means which consists mainly of male thread receivers provided with female threads provided to extend from each end of the frame corner via the frame side to a corresponding end of the other frame corner or female threads provided in the frame side intermediate portions and male threads provided for mating with the male thread receivers or the female threads of the frame corners.

The screen can be attached and detached with a combination of the screen hooking tools 22 and the screen frame arranged variable in the length of its frame sides.

This allows the screen joined with the screen hooking tools 22 to be detached from the screen frame after completion of the printing and stored with no tension being applied. Accordingly, the screen can be protected from over-stretching or distorting when is stored and thus increased in the operating life and the storage period. This is particularly advantageous when the same printing is repeated at equal or different intervals of time.

After completion of the printing, the screen hooking tools 22 joined to the screen are removed from the screen frame and saved for re-use. Also, their storage with the screen which is not bulky requires no extended space and will thus be economical. Their transportation will also be less troublesome.

As the screen hooking tools 22 are removed from the screen frame just after completion of the printing and minimized in both the weight and the size, they can be stored and transported with no difficulty.

(1) FIG. 6 illustrates an arrangement of the screen frame arrange variable in the side length (excluding the screen hooking tools 22 and the receptacles for the screen hooking tools 22).

The frame corners 14, 14a, 14b, and 14c of an L shape are slidably linked to one another to construct the screen frame.

More particularly, the male threads 15, 15a, 15b, and 15c of the frame corners are arranged threading in the female threads 16, 16a, 16b, and 16c of the corresponding frame corners to construct the screen frame.

The male thread has a hex wrench hole provided in the top thereof for turning with a hex wrench. The top of the make thread is movably fitted in the frame corner so that the force of turning applied from the outside can be transmitted to the female thread.

When the male threads 15, 15a, 15b, and 15c are turned leftward and rightward, the screen frame can expand or contract.

The turning of the make threads may be driven by an external servo motor. Alternatively, the turning movement can desirably be controlled by a computer calculating discrepancy of image between the screen and its print from the location of image positioning markings at every action of the printing and determining the distance for movement of the screen frame.

As the screen frame is varied in the length of its frame sides by the action of the threads, its spreading of the screen can be controlled precisely and favorably.

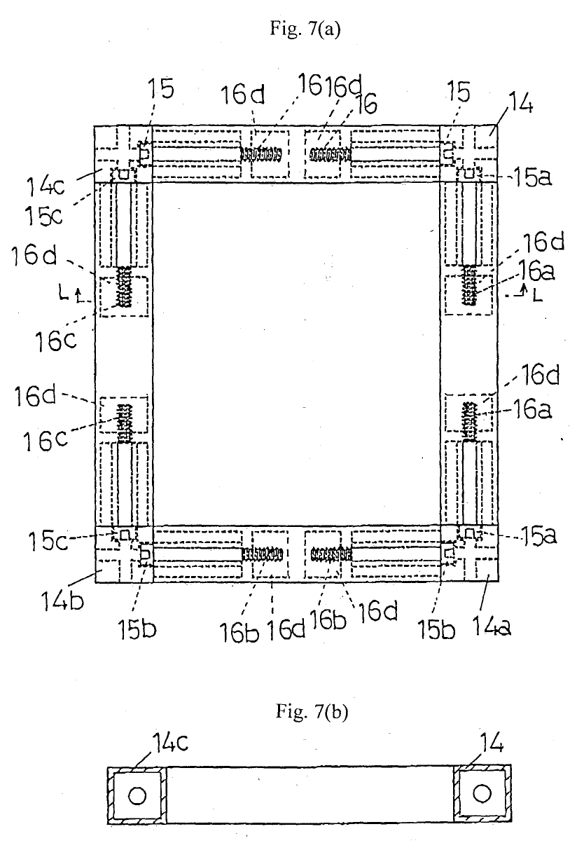

(2) FIG. 7 is explained.

The construction is similar to that shown in FIG. 6 and has make thread receivers 16d provided in an intermediate of each frame side. The male thread receivers 16d include female threads 16, 16a, 16b, and 16c located in the intermediate of a hollow portion of the frame side of the screen frame. When the screen frame is great in the size (e.g., 2 m×2 m), the male threads 15, 15a, 15b, and 15c have to be lengthened in the construction (1). This construction employs the make thread receivers 16d thus permitting the male threads not to be lengthened.

The function of this construction is identical to the previous construction (1) and will be explained in no more detail.

(Embodiment 4)

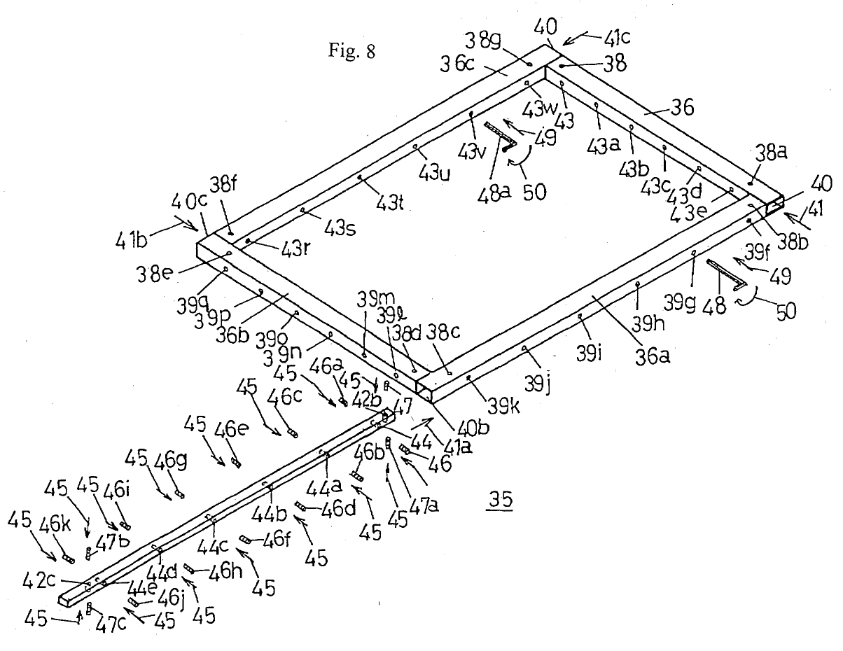

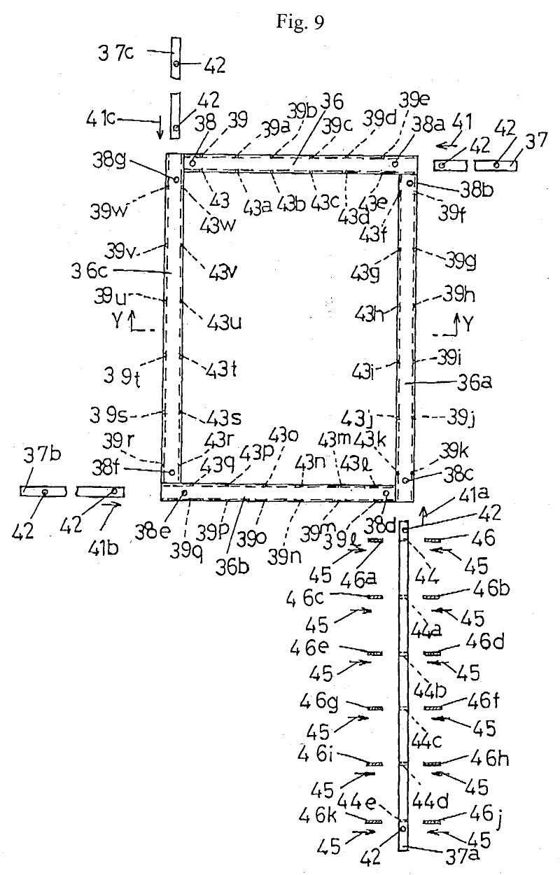

Embodiment 4 will be described referring to FIGS. 8, 9, 10, 11, and 12.

This is an attempt to have a screen frame arranged for finely controlling the tension on a screen to correct any unwanted distortion or skew on prints when the screen has been attached.

Such a hollow screen frame 35 is provided for finely controlling the tension on a screen printing screen when having been attached, spread, and operated for trial printing.

The hollow screen frame 35 comprises four frame sides 36, 36a, 36b, and 36c made of a hollow (30×40 mm in cross section) metal tube (of aluminum at a thickness of 2 mm), having openings 40, 40a, 40b, and 40c respectively provide in each end thereof, and joined by welding to one another to build a 950×950 mm construction.

As shown in FIG. 8, the frame sides 36, 36a, 36b, and 36c have outer thread apertures 39, 39a, 39b, 39c, 39d, 39e, 39f, 39g, 39h, 39i, 39j, 39k, 391, and 39m provided in the outer surface thereof respectively, six each side, inner thread apertures 43, 43a, 43b, 43c, 43d, 43e, 43f, 43g, 43h, 43i, 43j, 43k, 431, 43m, 43n, 43o, 43p, 43q, 43r, 43s, 43t, 43u, 43v, and 43w provided in the inner surface thereof respectively, six each side, and retaining thread apertures 38, 38a, 38b, 38c, 38d, 38e, 38f, and 38g provided in the upper surface at both ends thereof for retaining tension adjusting bars.

The four tension adjusting bars have thread apertures provided therein into which the tension adjusting screws are threaded. For example, the tension adjusting bar 37a has thread apertures 44, 44a, 44b, 44c, 44d, and 44e provided therein. The other three are identical. The tension adjusting bars 37, 37a, 37b, and 37c (25×25×900 mm) which are made of a metal (such as iron or steel) or a resin material and are equal on the length to the hollow of the frame sides are inserted into the openings 40, 40a, 40b, and 40c of the hollow frame side of the screen frame 36 from the directions denoted by 41, 42, 43, and 44.

Each of the tension adjusting bards has thread apertures 42, 42a, 42b, 42c, 42d, 42e, 42f, and 42g provided in both ends thereof for receiving the retaining screws.

The tension adjusting bars threaded with the tension adjusting screws into their thread apertures are inserted into the opening of the corresponding hollow frame sides. The tension adjusting bar 37 is secured to the corresponding frame side by retaining screws 47b and 47c threaded vertically from the retaining screw apertures into its both ends (50 mm inward from the end) (as equally at the other side not shown). The retaining screws retaining the tension adjusting bars at both ends to their respective frame sides serve as the fulcrums for deflecting the frame side 36, 36a, 36b, and 36c with the use of tension adjusting screws at the intermediate.

For deflecting each frame side of the screen printing screen frame to control the tension on the screen, the tension adjusting screws are threaded in the tension adjusting bar 37 from corresponding thread apertures provided in the frame side as denoted by 46, 46a, 46b, 46c, 46d, 46e, 46f, 46g, 46h, 46i, 46j, 46k, 461, and 46m.

The screws in this embodiment are headless or set screws. It is however understood that the screws are not limited to those but may be common machine screws with equal success.

As the tension adjusting screws are accessible through the thread apertures in the frame sides, they can be turned with a wrench 48 or 48a in the direction denoted by 50 in FIG. 8 for controlling the tension on the screen.

The tension adjusting screws are not limited to six in the embodiment but may be increased or decreased depending on the length of the frame side.

The action of the hollow screen frame 35 will now be described in more detail.

When the screen attached to the hollow screen frame 35 has been spread and operated for trial printing, the tension adjusting screws 46, 46a, 46b, 46c, 46d, 46e, 46f, 46g, 46h, 46i, 46j, 46k, 461, and 46m threaded into the tension adjusting bar 37 through the thread apertures of the frame side 36a are turned to move horizontally to and from the inner walls at the hollow of the frame side 36a. As the result, the frame side 36a can slightly be deflected thus eliminating any unwanted distortion or skew on the screen.

The tension adjusting screws 46 may be turned with the use of a wrench 48 or 48a manually or by the action of an external servo motor.

Alternatively, the adjustment for controlling the tension may be conducted by a computer calculating discrepancy in an image between the screen and its print from the location of image positioning markings at every action of the printing and determining the distance for movement of the screen frame.

It was found that the printing with the screen of which the tension was controlled by this manner created a quality of prints with no distortion or skew.

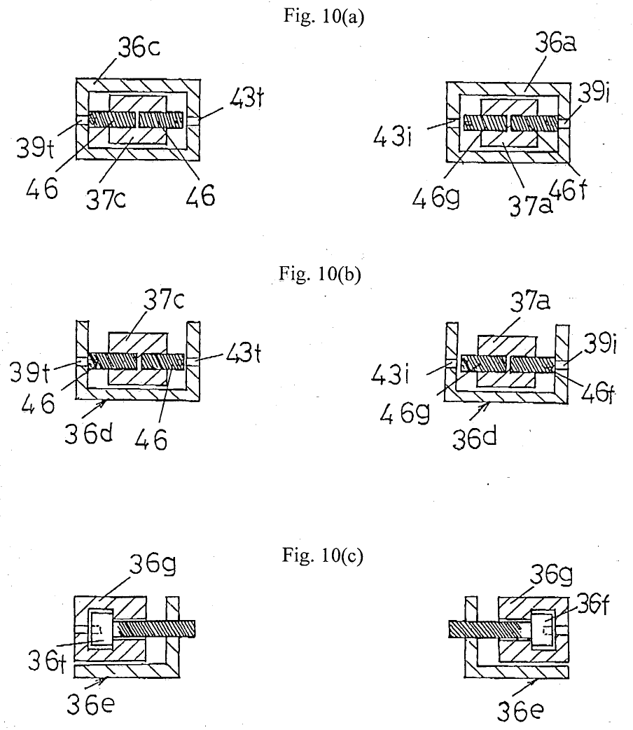

FIG. 10b is a cross sectional view of a modification of the frame side which has a C shape 36d in the cross section. In this modification, distortion or skew on the screen can be eliminated using the tension adjusting bars 37 and the tension adjusting screws 46. As the tension adjusting bars are secured to the bottom of the frame sides (as not shown), the same advantageous effect as of the embodiment can be obtained.

FIG. 10c illustrates an L shape 36e in the cross section of the frame side of the screen frame. Similarly, distortion or skew on the screen can be eliminated using the tension adjusting bars 37 and the tension adjusting screws 46. As the tension adjusting bars 37 are secured to the bottom of the frame sides (as not shown), the same advantageous effect as of the embodiment can be obtained. Also shown are the tension adjusting screws of a set screw type 36f.

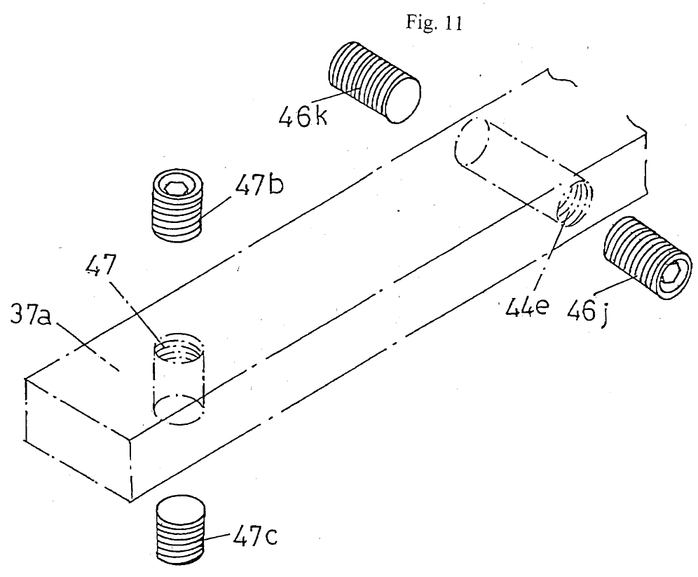

FIG. 11 illustrates a relationship between the tension adjusting bar 37 and the tension adjusting screws 46. As shown, a pair of the tension adjusting screws are inserted from both sides of the frame side while a pair of the retaining screws are inserted into the tension adjusting bar from above and below.

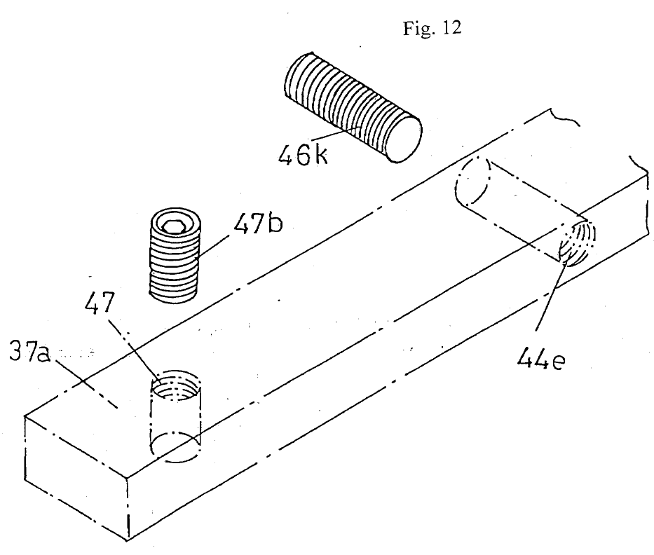

FIG. 12 illustrates another relationship between the tension adjusting bar 37 and the tension adjusting screws 46. As shown, the tension adjusting screw is inserted from the inner side of the frame side while the retaining screw 38 is inserted into the tension adjusting bar from above.

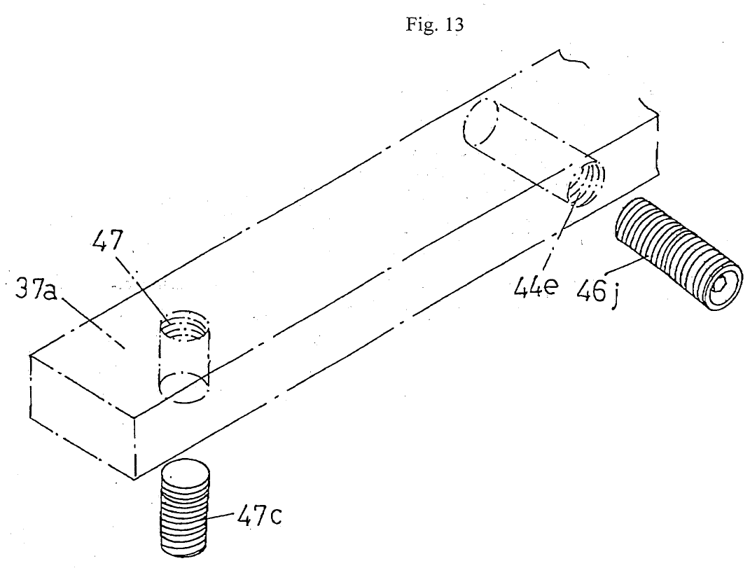

FIG. 13 illustrates a further relationship between the tension adjusting bar 37a and the tension adjusting screws 46. As shown, the tension adjusting screw is inserted from the outer side of the frame side while the retaining screw 47c is inserted into the tension adjusting bar from below.

1. A screen printing screen frame which is variable in the length of its frame sides and to which a screen is attached or with the use of screen hooking tools fixed to the screen, wherein there is provided a screen frame constituted by combining screen frame side or a screen frame side intermediate portion fitted loosely to an end portion of each corner of the screen frame, the screen hooking tools fixed to the screen, and fitting portions or joints of the screen fitting and hooking the screen hooking tools on the upper surface of each frame side of the screen frame for detachably, and screen frame side length extensible means which consists mainly of male thread receivers provided with female threads provided to extend from each end of the frame corner via the frame side to a corresponding end of the other frame corner or female threads provided in the frame side intermediate portions and male threads provided for mating with the male thread receivers or the female threads of the frame corners.

2. A screen printing screen frame having frame sides made of a metal or a synthetic resin material and arranged of an orthogonal shape, a hollow orthogonal shape, a C shape, or an L shape in the cross section for spreading a screen printing screen, wherein the frame sides of a hollow tube is closed or the frame sides of a hollow tube is provided with openings at one end and having an orthogonal shape or a C shape or an L shape in the cross section and welded or fixed to one another, a number of thread apertures provided in the side surfaces of the hollow or orthogonal frame sides or in the inner or outer side surface or the inner, outer, or both side surfaces of the C shape frame sides or in the side and outer sides of the L shape frame sides, tension adjusting bars having the predetermined number of thread apertures and the predetermined number of female thread apertures provided at a corresponding position to the thread apertures and tension adjusting screws threaded into the female thread apertures and inserted into or built-in the hollows of the frame sides or into the orthogonal frame sides or into the C shape of the C shape frame sides or into the L shape frame sides, wherein the tension on the screen is controlled by the frame sides deflecting horizontally with the tension adjusting screws moving forward and backward thus to eliminate unwanted distortion or skew of images on a print.

3. A method of bonding, curing, and embossing of mesh or sheet screens comprising the steps of:
butt joining or overlap joining screens together; providing a peelable sheet or an embossed peelable sheet on the upper, lower, or both sides of the bonded or cured joint and securing the joint with an adhesive agent or by thermal fusing or providing a set of molds to the joint and filling the molds with a molding agent; removing the peelable sheet or the embossed peelable sheet or the molds after the molding-agent is cured; and smoothing the upper, and lower, or both sides of the bonded or cured joint, whereby a step at the joint between the screens is filled or the mesh is sealed with the adhesive agent and the screens are covered with a layer of the adhesive agent or embossed at the surface.

4. A method of spreading a screen printing screen comprising the steps of:
providing hooking portions in a screen frame, which is variable in each side length, for accepting screen hooking tools; hooking the screen hooking tools of a screen into the hooking portions or fixing the screen to the screen frame; and adjusting the length of each side of the screen frame with the use of screen frame adjusting means to give a tension on the screen suited for the printing.

5. A screen frame which is variable in the length of its sides comprising assembling four L-shaped corners and four frame sides, which have insertion apertures provided in both ends thereof for accepting the L-shaped corners, by inserting the four L-shaped corners at their end into the insertion apertures to develop a screen frame construction provided with screen frame side length extensible means, or
locating four L-shaped frame sides, each frame side composed of a long side and a short side joined in an L shape and has an insertion aperture provided in one end of the long side thereof for accepting the short side of an adjacent L-shaped frame side, so that the long side of each frame side is opposite to the short side of a neighbor frame side and inserting the short sides into the corresponding long sides to develop a screen frame construction provided with screen frame side length extensible means, or
assembling four L-shaped corner frame side, defined by separating a screen frame at the center of each side and having insertion apertures provided in both ends thereof for accepting auxiliary frame sides, by inserting the auxiliary frame sides into the corresponding insertion apertures of the L-shaped corner frame sides to develop a screen frame construction provided with screen frame side length extensible means.
